(19) United States
(12) Patent Application Publication
(10) Pub. No.: US 2015/0290823 A1
(43) Pub. Date: Oct. 15, 2015

(54) STACK CUTTER

(71) Applicant: PLUS Corporation, Tokyo (JP)

(72) Inventor: Ryo Yasui, Tokyo (JP)

(21) Appl. No.: 14/672,917

(22) Filed: Mar. 30, 2015

(30) Foreign Application Priority Data
Apr. 11, 2014 (JP) 2014082373

(51) Int. Cl. B26D 1/10

(52) U.S. Cl. CPC B26D 1/105

(57) ABSTRACT

To allow a user to operate handling means of a stack cutter with better operational feeling.

A stack cutter includes a blade which is brought down while keeping its length generally parallel to a surface of object. The blade in this case has a thickness of not smaller than 0.4 mm and not larger than 0.9 mm.

### CLAIM OF PRIORITY TO RELATED APPLICATION

The application claims priority from Japanese Patent Application No. 2014-082373 filed Apr. 11, 2014, the disclosure of which is incorporated herein by reference in its entirety.

### BACKGROUND OF THE INVENTION

1. Technical Field

The present invention relates to a stack cutter and, more particularly, to a manual stack cutter. A stack cutter as used herein refers to a manual stack cutter unless otherwise noted.

2. Background Art

When it is necessary to cut object such as multiple sheets of paper or layers of resin films stacked on top of each other, a stack cutter is used for precise and rapid cutting of them.

Stack cutters that have been used for the longest time are of the type with a long blade hinged to a marginal edge of a cutting base at one end of the blade. A user holds a handle provided at the other end of the blade and brings the blade down in pivotal motion toward the cutting base to cut through the object placed on the cutting base. There is no single common name for stack cutters of this type, but they are herein referred to as swing guillotine cutters.

Different types of stack cutters have then been proposed and practically used. Examples include stack cutters with a blade that is brought down while keeping its length generally parallel to the cutting base to cut through the object placed on the cutting base. Other examples include a cutting base, a straight guide member placed on the cutting base, and a blade that is held perpendicular to the cutting base and can rotate and move along a straight path as guided by the guide member. A user slides the rotating blade horizontally along the guide member to trim the object placed on the cutting base. There is also no single common name for stack cutters of these types, but the former ones are referred to as horizon guillotine cutters and the latter ones are referred to as sliding blade trimmers in this specification.

Swing guillotine cutters have a thick, heavy blade. The blade may be more than 5 mm thick. When the blade is pulled down, object is pressed and cut through in one operation (at once) with the weight of the blade itself and a large pressure applied to the blade.

The same applies to horizon guillotine cutters. Horizon guillotine cutters were developed as an extension of swing guillotine cutters and thus they also have a thick, heavy blade similar to the one included in the swing guillotine cutters. When the blade is brought down horizontally, object is pressed and cut through in one operation (at once) with the weight of the blade itself and a large pressure applied to the blade.

On the contrary, sliding blade trimmers have a rotary or round cutting blade. The rotary blade slides up and down on object. This blade rolls on and cuts through the object as if a box cutter or a snap-off blade cutter cut through it. Because of their cutting principle, blades of sliding blade trimmers are as thin as, for example, 1 mm or less.

Swing and horizontal guillotine cutters both require that a user exerts a large force to begin movement of the blade for cutting. Among them, horizontal guillotine cutters can more easily be modified with the addition of a component that uses leverage to amplify the force exerted by a user, as a part of a mechanism for moving the blade. This makes it possible to reduce the force to a certain degree that the user should exert to move the blade.

On the other hand, sliding blade trimmers require users to exert much less force to cut through object but the blade can provide only small depth of cut with a single path, i.e., has a cutting capacity for only few sheets at a time in typical products. When a user attempts to cut through thick object such as a large stack of papers, he or she should move the blade up and down many times to achieve complete cut of the object.

In view of the foregoing, the present inventor had thought that an improvement of a horizon guillotine cutter would lead to development of a stack cutter with which users can cut through thick object including, for example, a stack of a relatively large number of sheet-like materials without exerting a significant force to move the blade. In particular, reduction in thickness and weight of a blade of horizon guillotine cutters can, in turn, reduce the force that a user applies to move the blade at least by an amount corresponding to the lost weight of the blade.

Experiments had demonstrated that, however, thinner blades of horizon guillotine cutters could not withstand the force exerted by the object in contact with them, and were finally impaired. Regardless of whether a swing-type or a horizon-type, it has commonly been believed in the field of stack cutters that blades of guillotine cutters should be thick enough to ensure sufficient stiffness of the blades. Since all blades in conventional guillotine cutters have been produced under the premise of this, the aforementioned experimental results can be considered to be reasonable.

With due consideration to the above, the present invention is, therefore, directed to provide a stack cutter with which a user can cut through relatively thick object, such as a large stack of papers in one operation without exerting a significant force to move a blade.

### BRIEF SUMMARY OF THE INVENTION

According to the studies made by the present inventor by gradually reducing the thickness of blades, starting from a thickness of around 5 mm, in a stack cutter comprising a blade for cutting an object with an edge of the blade being pressed against and generally parallel to a surface of the object, that is, a horizontal guillotine cutter, it was found that the blade will be impaired when the thickness becomes smaller than a certain threshold, due to a large force exerted by the object to be cut.

The present inventor has found, however, the fact that object can be cut without impairment of the blade by further reducing the thickness of the blade than the aforementioned certain threshold, contrary to the generalized perception in the field of stack cutters

The present invention is based on this finding.

The present invention is a stack cutter comprising a blade for cutting an object, an edge of the blade being pressed against and generally parallel to a surface of the object, wherein the blade has a thickness of 1 mm or smaller; handling means for being operated by a user so that the blade located away from the object moves toward the object; and linking means for transmitting a force exerted on the handling means to the blade.

As described above, the present inventor has found that, by gradually reducing the thickness of blades, starting from a reasonable thickness, in a stack cutter comprising a blade for cutting an object with an edge of the blade being pressed against and generally parallel to a surface of the object, the blade will be impaired when the thickness becomes smaller than a certain threshold, and that object can be cut without impairment of the blade by further reducing the thickness of the blade. The applicant has found that 1 mm is the largest thickness of the blade obtained after gradually reducing the thickness of blades, starting from a reasonable thickness, until the blade is impaired and further reducing the thickness, with which object can be cut without impairment of the blade. In other words, in a stack cutter comprising a blade with a thickness of 1 mm or smaller, the blade will hardly be impaired upon cutting of object. The applicant has confirmed this fact through simulations.

In addition, in a stack cutter using such a thin blade, the blade itself has a small weight. It has been found through the studies made by the present inventor that only a smaller force is exerted by a user when he or she operates handling means to move the blade for cutting the object probably because a cutting mechanism is based on the sharpness of the blade rather than relying on pressure as in conventional stack cutters.

The blade in the present invention is “for cutting an object with an edge of the blade being pressed against and generally parallel to a/the surface of the object.” The term “generally parallel” in this application includes cases where the edge (the entire sharpened portion of the blade that is sharpened for cutting) of the blade is slightly (such as within 5°) inclined to the surface of the object. The entire blade may move at a slight angle to the object in a predetermined plane that is perpendicular to the surface of the object as long as the edge of the blade is kept parallel to or only slightly inclined to the surface of the object and the edge of the blade moves within the predetermined plane.

In this application, the term “object” may represent or include a single item or two or more items. The material of the item(s) is not specifically limited and may be, for example, paper or a plastic. The shape of the item(s) is not specifically limited but is preferably a film- or sheet-like shape.

The blade in the stack cutter of the present invention may have a thickness of 0.9 mm or smaller.

With a blade having a thickness of 0.9 mm or smaller, a user can cut through object only with a small force even when the object has a relatively large thickness (such as when the thickness of each sheet to be cut is increased or the number of sheets to be cut is increased).

The blade in the stack cutter of the present invention may have a thickness of 0.7 mm or smaller.

With a blade having a thickness of 0.7 mm or smaller, a user can cut through object only with a smaller force even when the object has a relatively large thickness.

The blade in the stack cutter of the present invention may have a thickness of 0.5 mm or smaller.

With a blade having a thickness of 0.5 mm or smaller, a user can cut through object only with a much smaller force than in the case of 0.7 mm thickness, even when the object has a relatively large thickness.

The blade in the stack cutter of the present invention may have a thickness of 0.4 mm or larger.

A blade having a thickness of smaller than 0.4 mm has an increased risk of being impaired, but this risk can be reduced by determining the thickness of the blade to be 0.4 mm or larger.

The blade may comprise a carbon tool steel or a steel material having at least the same hardness as the carbon tool steel. Carbon tool steels are hard and are suitable for use in making a blade of a stack cutter of the present invention. A carbon tool steel or a steel material having at least the same hardness as the carbon tool steel used as a material for making a blade reduces the risk of blade impairment and allows a user to cut through object with a smaller force.

An edge angle of the blade in the stack cutter of the present invention may fall within a range of 30°±5°.

A larger edge angle of the blade causes a higher resistance that acts on the blade by the object, which increases the amount of force that a user should exert to operate the handling means for cutting through the object. On the other hand, a smaller edge angle of the blade enhances the risk of blade impairment. In view of these, it is preferable that the edge angle falls within the aforementioned range in a manual stack cutter comprising a blade having a thickness of 0.9 mm or smaller and preferably 0.4 mm or larger.

The present inventor also suggests a blade that is used in combination with a stack cutter to achieve similar effects to those obtained in the stack cutter described above.

For example, the blade is for being used in a stack cutter, the stack cutter comprising the blade for cutting an object, an edge of the blade being pressed against and generally parallel to a surface of the object, handling means for being operated by a user so that the blade located away from the object moves toward the object, linking means for transmitting a force exerted on the handling means to the blade, and fixing means being capable of removably fixing the blade attached to the linking means, wherein the blade has a thickness of 1 mm or smaller and has a fixed portion capable of being removably engaged with the fixing means.

This blade may have similar features to those of the blade contained in the stack cutter described above.

### BRIEF DESCRIPTION OF THE DRAWINGS

FIG. 1 is a perspective view showing a structure of a stack cutter according to an embodiment of the present invention;

FIG. 2 is a perspective view showing the stack cutter in FIG. 1 with a cutting base folded up;

FIG. 3 is a cross-sectional view used to describe a structure of a blade assembly of the stack cutter in FIG. 1;

FIG. 4 is a top plan view of the cutting base and a guide member of the stack cutter in FIG. 1;

FIG. 5 is a perspective view of an arm of the stack cutter in FIG. 1, with the arm in a locked state;

FIG. 6 is a view showing a link mechanism of the stack cutter in FIG. 1;

FIG. 7 is a view that schematically shows the motion of a blade of the stack cutter;

FIG. 8A is a back view of a blade of the stack cutter in FIG. 1, FIG. 8B is a side view of the same blade of the stack cutter in FIG. 1, FIG. 8C is a side view of another blade, and FIG. 8D is a side view of yet another blade; and

FIG. 9 is a view schematically illustrating a test method.

FIG. 10A is a table showing measurements.

FIG. 10B is a graph showing forces.

FIG. 10C is a graph showing results.

### DETAILED DESCRIPTION OF THE INVENTION

A preferred embodiment of the present invention is described in detail below with reference to the drawings.

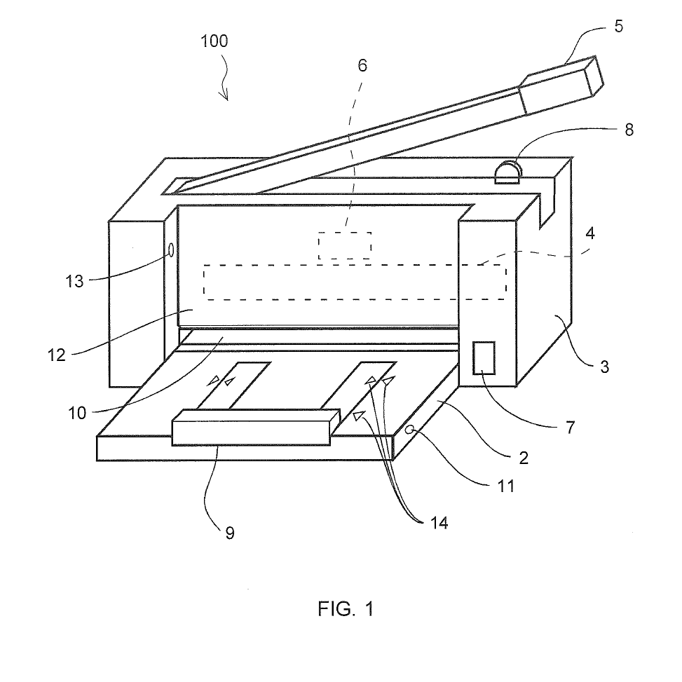

FIG. 1 is a perspective view of a stack cutter 100 according to this embodiment.

The stack cutter 100 comprises a cutting base 2 on which object such as a sheet of paper or a resin film to be cut is held or placed, and a body case 3 provided at one end of the cutting base 2.

The body case 3 contains a link mechanism described below, a blade assembly 4 including a blade described later, and a light emitting unit 6 for projecting a light beam onto the topmost of the object. The light beam provides a cutting line along which the object is cut when the blade is brought down. The light emitting unit 6 is configured with, but not limited to, an LED, a slit through which the light beam from the LED is emitted as a linear beam, and a lens that provide an image by the light beam from the slit onto the topmost of the object. A user can cut the object easily and precisely while seeing the light beam produced by the light emitting unit 6.

An arm 5, a switch 7, a locking member 8, and a guide member 9 are attached to the body case 3. The arm 5 is used by the user to move the blade assembly 4 up and down. The switch 7 is for turning on and off the light emitting unit 6. The locking member 8 is used to lock the arm 5 with the arm 5 housed in the body case 3. The guide member 9 can be slid from a position at the other end of the cutting base 2.

The proximal end of the arm 5 is housed within the body case 3.

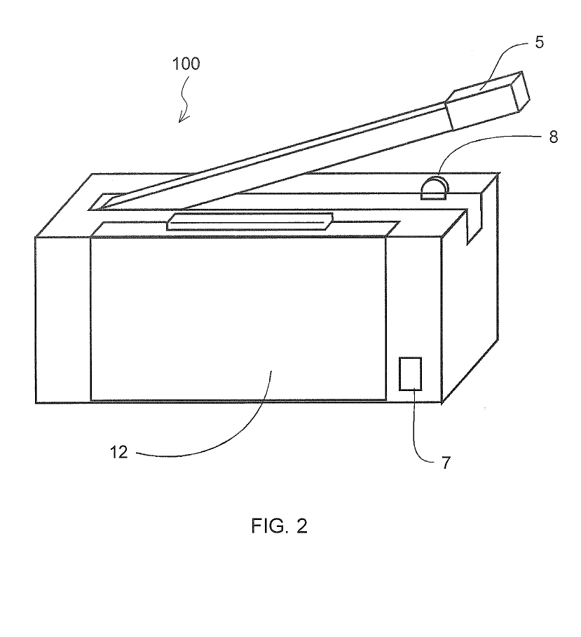

As shown in FIG. 2, the cutting base 2 can be fitted into a cutting base recess 12 that is formed in the outer surface of the body case 3. The cutting base recess 12 has a shape corresponding to the contour of the cutting base 2.

In order to ensure this storage, lugs or projections 11 are provided on both sides of the cutting base 2. In addition, bores 13 are formed in the side surfaces of the cutting base recess 12 in the body case 3 at the positions corresponding to the projections 11. When the cutting base 2 is received in the cutting base recess 12, the projections 11 engage with the respective bores 13. This results in temporal holding of the cutting base 2 in the body case 3.

In general, the stack cutter 100 before and after its use is in the state shown in FIG. 2 where the cutting base 2 is received in the body case 3.

After the use of the stack cutter 100 is completed, the switch 7 is manipulated to turn off the light emitting unit 6 and make the light beam providing the cutting line disappear. The cutting base 2 is then folded up into the body case 3.

Conventional stack cutters take up a large storage space after their use. In contrast, in the stack cutter 100 according to this embodiment, the cutting base 2 can be folded up vertically which otherwise takes up a large space for horizontal placement. This allows compact storage of the stack cutter 100.

When received in the body case 3, the cutting base 2 covers and hides an insert opening 10 formed in the body case 3. The insert opening 10 is to allow a user to insert the object to be cut into the body case 3 (i.e., underneath a blade described later). The stack cutter 100 has excellent safety because the insert opening 10 is covered and hidden with the cutting base 2 when the stack cutter 100 is not in use. This reduces the risk of, for example, causing an unexpected injury to fingers of a child inserted unknowingly into the insert opening 10.

While not illustrated in the figure, another switch is provided within the body case 3. This switch is turned on and off depending on the position of the cutting base 2. More specifically, this switch is designed to turn off the light emitting unit 6 when the cutting base 2 is received in the body case 3. As described above, the light emitting unit 6 is usually turned on and off by the switch 7. With the additional switch operated according to the position of the cutting base 2, however, the light emitting unit 6 in the stack cutter 100 is automatically turned off just in response to the fitting of the cutting base 2 into the body case 3 even if the user forgets to turn off the switch 7 after he or she is done with the stack cutter 100. It is thus possible to avoid leaving the light emitting unit 6 turned on even if the user forgets to operate the switch 7 after he or she is done with the stack cutter 100.

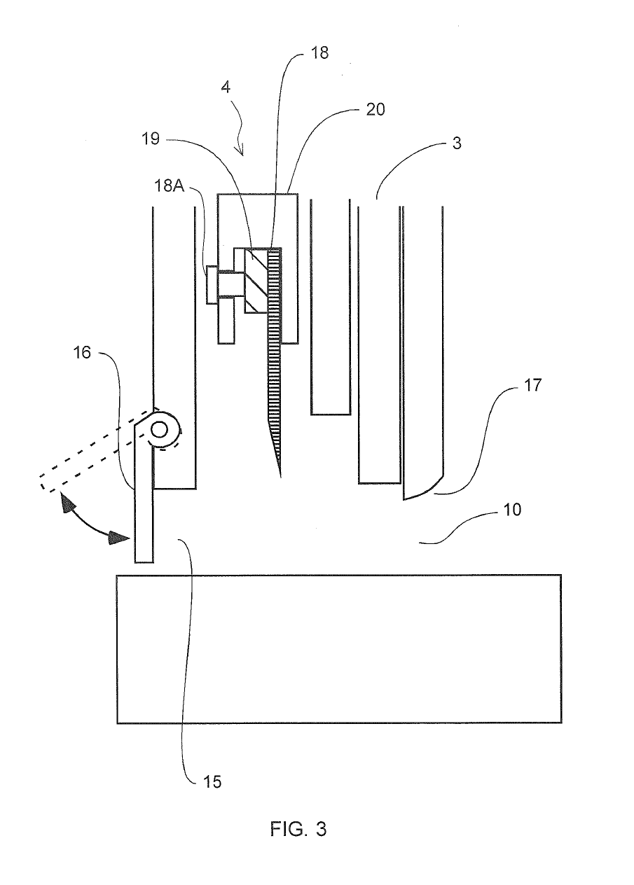

FIG. 3 shows a cross-sectional view of the blade assembly 4 and components around it.

As described above, the body case 3 has the insert opening 10 through which the object is inserted into the body case 3. A tapered section 17 that is tapered toward the insert opening 10 is provided above the insert opening 10. The tapered section 17 serves to facilitate insertion of the object into the body case 3 through the insert opening 10. More specifically, when the object to be cut is a stack of items such as multiple sheets of paper or layers of films, the advancing edges of the items may sometimes be warped up. In such a case, the tapered section 17 serves to guide the warped edges of the items into the insert opening 10. A user can thus easily slip or insert the stack (object) into the insert opening 10.

An exit opening 15 is provided in the surface of the body case 3 opposite to the insert opening 10. In this embodiment, a portion of the object fed into the body case 3 comes out through the exit opening 15. For example, when the object is a stack of items as above, they are fed into the body case 3 through the insert opening 10 and then cut in the body case 3 with their edges sticking out of the exit opening 15. In other words, when the object is cut, its leading edge is sticking out of the exit opening 15 and the opposite, trailing edge is sticking out of the insert opening 10.

By way of example, a transparent protective cover 16 is suspended from the outer wall of the body case 3 above the exit opening 15. The protective cover 16 is hinged to the body case 3. It is pushed by the edge of the object and moves up in pivotal motion to open the exit opening 15 as depicted by the arrow when the object comes out. This protective cover 16 then moves down in pivotal motion under its own weight to cover the exit opening 15 as depicted by the arrow when the object in the exit opening 15 is removed. The protective cover 16 does not swing further into the body case 3, so no object can be inserted through the exit opening 15 even if a user attempts to do so. The user can thus intuitively distinguish between the insert opening 10 and the exit opening 15. In addition, he or she is protected from nothing other than the object can also be inserted into the body case 3 through the exit opening 15, so that any accidental slip of a finger into the exit opening 15 can be prevented. This protective cover 16 is also one of the measures to increase the safety of the stack cutter 100.

The blade assembly 4 is configured with a blade 18, a reinforcing plate 19 bonded to the blade 18, and a frame 20 to which the combination of the blade 18 and the reinforcing plate 19 is fixed with a screw 18A. The frame 20 is a component to be mounted on the case 3 while the combination of the blade 18 and the reinforcing plate 19 is removable from the case 3.

The reinforcing plate 19 is a rectangular plate having the same length as the blade 18 and is integrated with the blade 18 by being fixed to the upper end of the blade 18. The reinforcing plate 19 combines the function of reinforcing the blade 18 and the function of fixing the blade 18 to the frame 20.

The frame 20 is generally inverted U-shaped in cross section with the open end of the U facing downwardly. It is slightly longer than the blade 18. The structure made up of the blade 18 and the reinforcing plate 19 is fixed in the space inside the generally U-shaped frame 20, with the upper surface of the structure contacting against the upper surface of the space in the generally U shape. The frame 20 has a screw hole formed therein which is not shown. The screw hole has a threaded inner wall. The aforementioned screw 18A is threadedly engaged with the screw hole. By tightening the screw 18A, the tip of the screw 18A is abutted to the side surface of the aforementioned reinforcing plate 19 of the structure made up of the blade 18 and the reinforcing plate 19 after the screw 18A is advanced. The structure is thus sandwiched between and held by the screw 18A on one side of the space in the generally U-shaped frame 20 and the inner surface of the space on the opposite side. In this way, the structure is fixed to the frame 20. On the other hand, when the screw 18A is loosened, the screw 18A is withdrawn and the fixture between the frame 20 and the structure is released.

As apparent from the above, the structure is designed to be able to be removed and attached from and to the frame 20. This is for allowing the user to replace the blade 18 (or the structure) that will wear out.

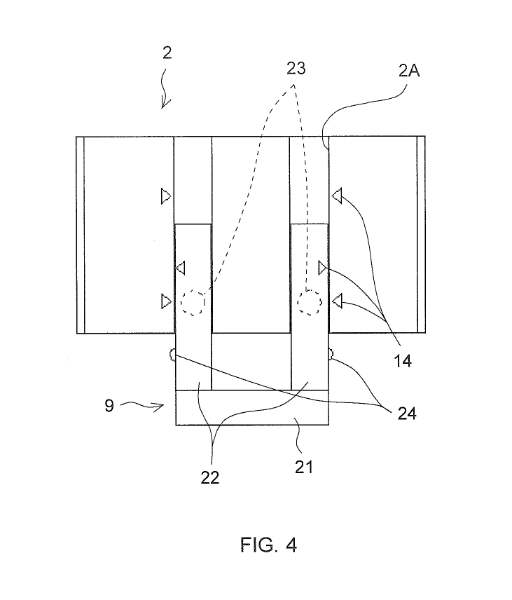

FIG. 4 shows a top plan view of the cutting base 2 and the guide member 9.

The guide member 9 has a pair of slider fingers 22 and a stopper 21. Each slider finger 22 is identical in cross section to a groove 2A having a rectangular cross section that is provided in the cutting base 2. The groove 2A has a length in the vertical direction from the perspective of FIG. 4. The slider fingers 22 can be moved vertically in the respective grooves 2A while being guided by the grooves 2A. The stopper 21 is connected to the bottom (from the perspective of FIG. 4) of the slider fingers 22 and extends from the slider fingers 22. The stopper 21 is for the user to set the side of the object against after he or she adjusts the placement of the slider fingers 22 appropriately in the lengthwise direction of the grooves 2A. With this, the user can place the object at a desired position. The upper surfaces of the slider fingers 22 are flush with the upper surface of the cutting base 2, so that the slider fingers 22 do not interfere with the positioning of the object.

Index marks 14 are provided at appropriate positions on the cutting base 2 and the guide member 9. The index marks 14 are provided at positions indicating the sizes of the object to be cut. The index marks 14 are provided for standard sizes of the object. For example, when the stack cutter is intended to be used for a stack of papers, then the standard sizes may be A4, B5, or some other A, B, or C series of paper sizes. The user can cut the object easily and precisely into any size such as one half of the object by cutting them after matching an edge of the object with an index mark. The user appropriately positions the guide member 9 relative to the cutting base 2 in such a manner that the index marks 14 on the guide member 9 and the cutting base 2 align with each other for expected size of the object that the user wants to cut. Merely by setting the side of the object against the stopper 21, the object can be positioned easily and precisely relative to the cutting base 2 or the cut position.

Magnets 23 are provided in the grooves 2A in the cutting base 2 at the positions corresponding to the aforementioned index marks 14. On the other hand, iron plates (not shown) that are attracted toward each magnet 23 by the magnetic force are embedded in the slider fingers 22 forming the guide member 9. The magnets 23 are positioned so that the plates are attracted toward the magnet 23 only at positions where the index marks 14 on the cutting base 2 and the guide member 9 align with each other. This provides automatic, precise and easy alignment between the index marks 14 on the guide member 9 and the cutting base 2 due to attraction of the plates toward the magnets 23 by roughly adjusting the relative position between the cutting base 2 and the guide member 9.

Furthermore, lugs or projections 24 are provided on the outer surface of each slider finger 22 of the guide member 9. The projection 24 is biased in the direction of the projection by a spring (not shown) provided in the guide member, but is withdrawn in the guide member 9 when an external force is applied. On the other hand, a bore is formed in the outer surface of each groove 2A of the cutting base 2 at the positions corresponding to the index marks 14 to receive the projection 24. When the user moves the slider fingers 22 of the guide member 9 in the lengthwise direction of the grooves 2A by gripping, for example, the stopper 21 of the guide member 9, the projections 24 latch into the bores giving “clicking” feeling to the user's hand through the guide member 9 only at the positions where the projections 24 latch into the bores. This clicking feeling is given only when the alignment is achieved between the index marks 14 on the guide member 9 and the cutting base 2. The user can use this clicking feeling to know whether the guide member 9 and the cutting base 2 are positioned correctly relative to each other using the index marks 14.

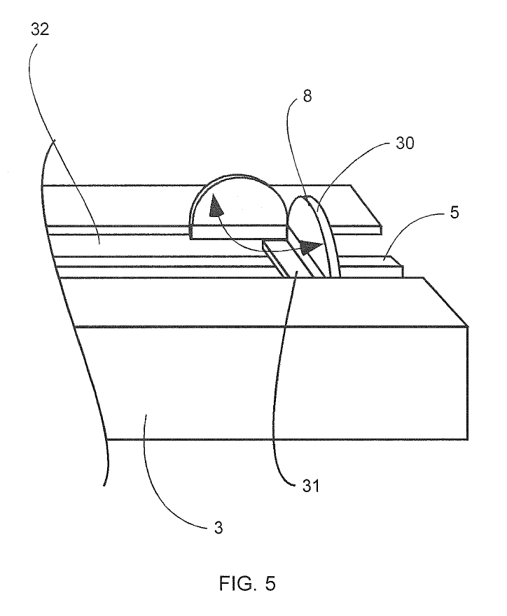

FIG. 5 is a perspective view showing the arm 5 housed in the body case 3 and locked with the locking member 8.

The locking member 8 is formed of, for example, a resin tab 30 and a metal, L-shaped arm keeper 31. The locking member 8 is provided on one side of the open end of an arm sheath opening 32 formed in the upper surface of the body case 3 in such a manner that the locking member 8 can turn as depicted by the arrows.

When the locking member 8 is turned over and across the arm 5, the arm 5 is prevented from moving up. As a result, the arm 5 housed in the body case 3 cannot escape from the body case 3.

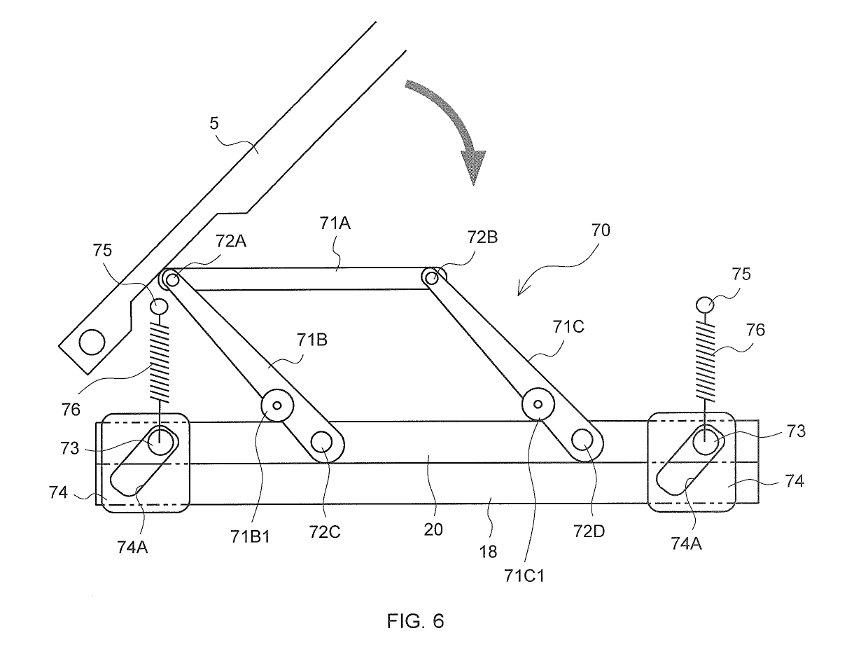

FIG. 6 is a schematic view of an example of a link mechanism 70 housed in the body case 3 of the stack cutter according to the present application. The link mechanism 70 is provided to transmit force from the arm 5 to the frame 20. The link mechanism 70 converts the swing motion of the arm 5 moved by the user into vertical movement of the blade 18 while keeping the edge of the blade 18 generally parallel to the upper surface of the object or the cutting base 2. The structure of the link mechanism is not limited to the one shown in FIG. 6 as long as the aforementioned conversion of the motion can be achieved.

The link mechanism 70 has a first link member 71A, a second link member 71B, and a third link member 71C, all of which have an elongated shape. The second link member 71B and the third link member 71C are equal in length to each other. Rollers 71B1 and 71C1 are attached to the second link member 71B and the third link member 71C, respectively, at positions near the lower ends thereof. The rollers 71B1 and 71C1 are sticking out toward the frame 20 and are rotatable about the shafts fixed to the second link member 71B and the third link member 71C, respectively.

One end of the first link member 71A is connected to the upper end of the second link member 71B by a first pivot joint 72A. The other end of the first link member 71A is connected to the upper end of the third link member 71C by a second pivot joint 72B. The first and second link members 71A and 71B are rotated about the pivot and relative to each other. The lower ends of the second link member 71B and the third link member 71C are connected to the frame 20 by third and fourth pivot joints 72C and 72D, respectively, so that the second and the third link members 71B and 71C are rotated about the pivot and relative to each other.

As a result, the first link member 71A, the second link member 71B, the third link member 71C, and a part of the frame 20 (a part of the frame 20 between the third pivot joint 72C and the fourth pivot joint 72D) forms a loop having a shape of a parallelogram with the first pivot joint 72A, the third pivot joint 72C, the second pivot joint 72B, and the fourth pivot joint 72D as vertices. This loop can be deformed by moving the first pivot joint 72A from the upper right to the lower left. In other words, the parallelogram loop can be flattened more as it moves toward the lower left from the shape illustrated in the figure and then raised as it moves toward the upper right. A spring (not shown) applies a biasing force to the loop that pushes the first pivot joint 72A to its original position where the first pivot joint 72A is located at an upper right to a certain degree.

Hollow cylindrical members 73 (which are not limited thereto) are provided on the frame 20. The hollow cylindrical members 73 are provided to engage guide members 74 to the frame 20. The guide member 74 is fixed to the body case 3 and has an oblique guide hole 74A. The hollow cylindrical member 73 is held within the guide hole 74A and can move along the length of the guide hole 74A. The direction of movement of the frame 20 is thus restricted to the direction along the length of the guide hole 74A.

The link mechanism 70 has fixture members 75. One end of the fixture member 75 is fixed to the body case 3 by predetermined means. The fixture member 75 is connected to the upper end of a lift-up spring 76 whose lower end is fixed to the hollow cylindrical member 73. The lift-up spring 76 is pressed and therefore an upper biasing force is always applied to the hollow cylindrical member 73 and, in turn, to the frame 20.

When the user moves down the arm 5, the arm 5 pushes the first pivot joint 72A downward. This deforms the aforementioned parallelogram loop as the first pivot joint 72A moves toward the lower left while keeping its parallelogram shape. The link receives a force by a spring which is not shown to move the first pivot joint 72A toward the upper right. The frame 20 receives a force by the lift-up spring 76 to pull it upward. When the user normally moves the arm 5, the force applied by the arm 5 to the first pivot joint 72A overcomes these forces. The frame 20 to which the hollow cylindrical member 73 is fixed then moves toward the lower left as the hollow cylindrical member 73 moves along the guide hole 74A while being guided by it toward the lower portion of the guide hole 74A. In this way, the blade 18 cuts the object placed on the surface continued from the cutting base 2 in the body case 3.

When the frame 20 is moving downward, the rollers 71B1 and 71C1 of the second link member 71B and the third link member 71C, respectively, are abutted against the upper portion of the frame 20. In the second link member 71B, the first pivot joint 72A acts as the point of effort, the third pivot joint 72C acts as the fulcrum, and the contact point between the roller 71B1 and the frame 20 acts as the point of load. In the third link member 71C, the second pivot joint 72B acts as the point of effort, the fourth pivot joint 72D acts as the fulcrum, and the contact point between the roller 71C1 and the frame 20 acts as the point of load. The force moving the arm 5 downward is amplified and transmitted to the frame 20 through the principle of leverage both in the second and third link members 71B and 71C. This will allow the user to move the arm 5 with less effort.

When the user is finished cutting the object and returns the arm 5 to an upper position, the frame 20 returns to an upper position by the biasing force applied by the lift-up spring 76. The parallelogram loop returns to its original position by the biasing force applied by the spring (not shown) that acts to the first pivot joint 72A to return it to its initial position. The stack cutter is now ready to cut through another object.

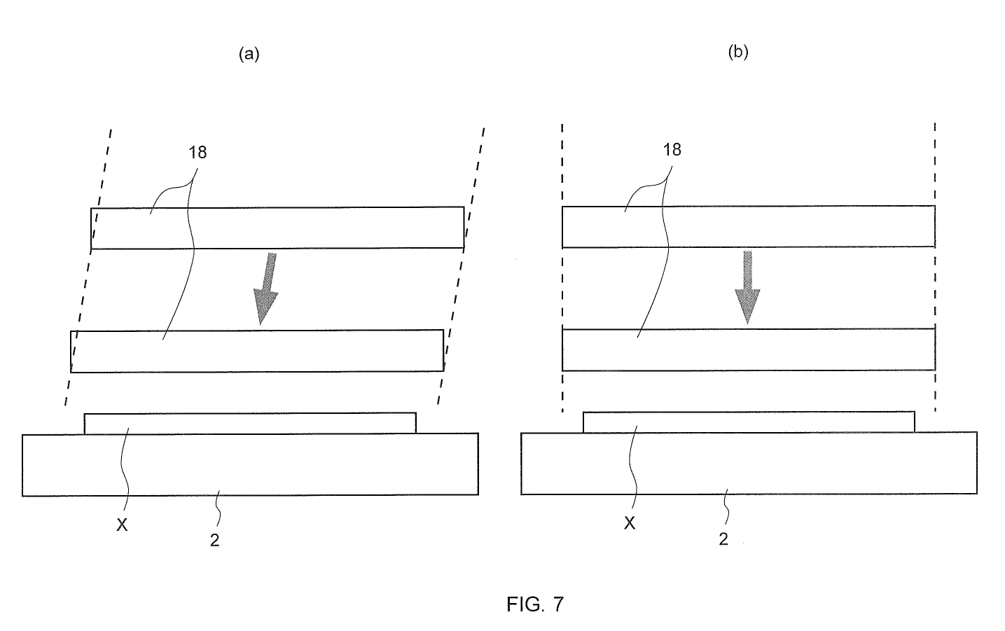

The blade 18 in this embodiment is brought down at a slight angle to the cutting base 2 while the edge of the blade is kept generally parallel to the upper surface of the object (in this embodiment, an item X as shown in FIG. 7(a)). However, another design may be used in which the blade 18 is brought down vertically while the edge of the blade is kept generally parallel to the upper surface of the item or object X, as shown in FIG. 7(b). Such a modification can easily be achieved by appropriate modifications of the link mechanism. As used herein in connection with the orientation of the edge (details of the edge will be described below) of the blade, the term “generally parallel to the upper surface of the object” includes cases where the edge of the blade is not exactly parallel to the upper surface of the object X (e.g., the edge of the blade makes an angle of 5 degrees or smaller) and where the angle changes as the blade 18 moves.

The blade 18 in this embodiment is described.

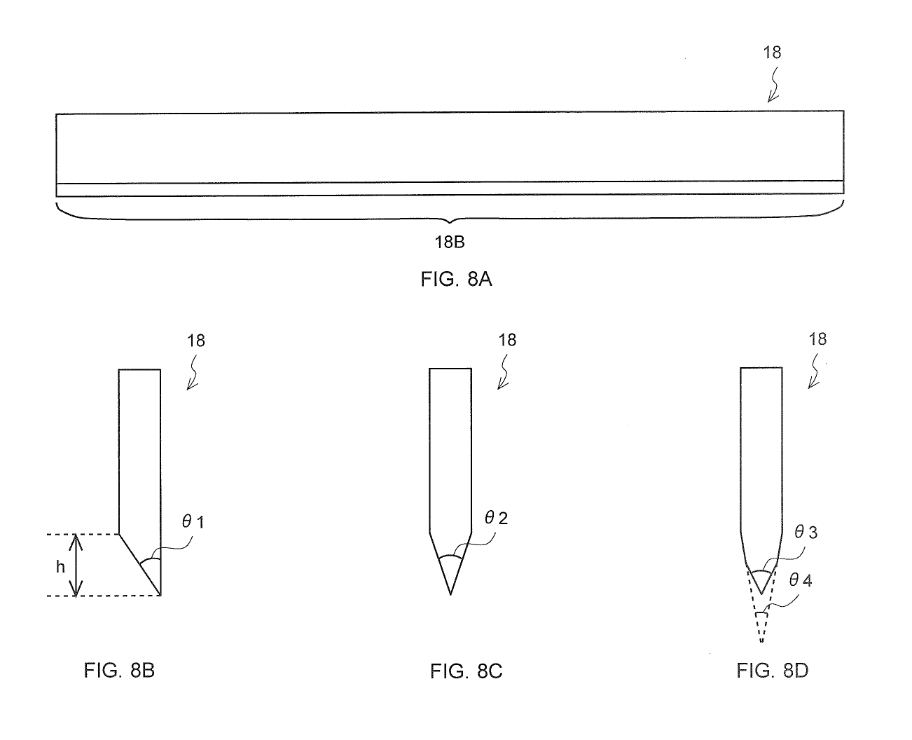

FIGS. 8A and 8B show back and side views, respectively, of the blade 18 in this embodiment.

The blade 18 in this embodiment has an elongated rectangular shape as shown in FIG. 8A. The length of the blade 18 is slightly shorter than the longitudinal length of the body case 3. The blade 18 has an edge 18B at the sharpened, lower cutting end thereof. The edge 18B typically spans the entire length of the blade 18.

The blade 18 in this embodiment is a single-edged blade as shown in 8(b). An edge angle θ1 of the blade 18 is 30°±5° in this embodiment but is not limited thereto. The edge angle in this range is suitable to reduce the force that a user applies to move the arm 5 when he or she cuts through the object.

The blade 18 is not necessarily single-edged. It may be a double-edged blade as shown in FIG. 8C. In this case, it is also preferable that an edge angle θ2 is 30°±5°. In addition, the blade 18 may be a double bevel blade as shown in FIG. 8D. In this case, the blade 18 has two different edge angles, θ3 and θ4, of which θ3 is preferably defined to be 30°±5°.

The harder the blade 18 is, the longer it will possibly hold its edge without being impaired and the better it can cut through the object. Material used for the blade 18 is not limited to a specific one but it is preferable that the blade 18 in this embodiment is made of a material such as carbon tool steel or other material having at least the same hardness as the carbon tool steel. Examples of carbon tool steel include SK grades of steel defined in Japanese Industrial Standards (JIS). More specifically, the blade 18 in this embodiment is made of SK2 grade steel.

### <Test Examples>

Five different blades 18 were subjected to a cutting test using the aforementioned stack cutter 100, in which one of the blades was attached to the stack cutter 100 to cut through object and the force exerted on the blade 18 was measured. A smaller force exerted on the blade 18 indicates that a user can push down the arm 5 with a smaller force, and a larger force exerted on the blade indicates that a user can push down the arm 5 with a larger force.

The stack cutter 100 used in this test was a prototype device that is equivalent in internal structures to a stack cutter (trade name PK113) scheduled to be released by the applicant after filing of this application. The blade 18 or the edge of the blade 18 is brought down at a slight angle to the surface of object while the edge of the blade 18 is kept generally parallel to that surface, as shown in FIG. 7(a). When a stack cutter other than the stack cutter in the examples herein is used for testing, absolute values of the forces exerted on the blade may be different from those described in this specification. In such cases, however, a relationship between the thickness of the blade and the force exerted thereon is considered to be identical. It is thus believed that differences in stack cutters used do not affect test results as long as the blade in the stack cutter is brought down at a slight angle to the surface of object while the edge of the blade is kept generally parallel to that surface.

The object to be cut is from one to fifty pieces of paper strip. The paper used was A4-size sheets of copier paper (ASKUL Multi Paper Super Economy A4, 80 μm thick, 64 g/m²) sold by ASKUL Corporation. The sheets were previously cut into rectangular strips in such a manner that the long side of each sheet was divided into 80 mm each and the short side was not divided. Each paper strip thus had an 80-mm short side and a long side that is equal in length to the short side of a sheet of the copier paper. These paper strips were cut along a line parallel to the 80-mm side.

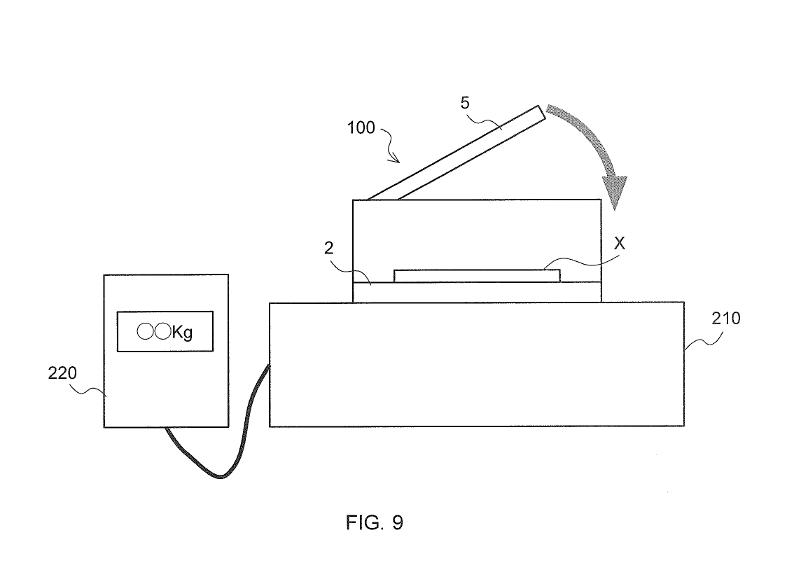

Forces exerted on the blade 18 were measured as follows. The stack cutter 100 with the test object loaded therein was placed on a platform 210 of a commercially available weight scale (Electronic scale WB-150, remote display version (white) manufactured by TANITA Corporation) as shown in FIG. 9 and the scale was reset to zero (the weight of the scale displayed on a display box 220 was reset to 0 kg with the object and the stack cutter 100 on top of the platform 210). Subsequently, the object X was cut in the stack cutter 100. The largest value displayed on the display box 220 during the cutting operation was determined as the magnitude of a force (kgf) that the blade 18 received from the object.

Blades of 1.6 mm, 1.2 mm, 0.9 mm, 0.7 mm, 0.5 mm, and 0.3 mm were attached alternately to change the thickness of the blade 18 attached to the stack cutter 100. The blades used were all single-edged blades made of a JIS-standard SK2 steel with an edge angle of 35°.

The number of paper strips (object) to be cut with the blade 18 was 1, 5, 10, 15, 20, 25, 30, 35, 40, and 50. When more than one paper strips were subjected to the test, they were stacked on top of each other and cut at once with the blade 18.

A test method is schematically shown in FIG. 9 and the results of trials are given below.

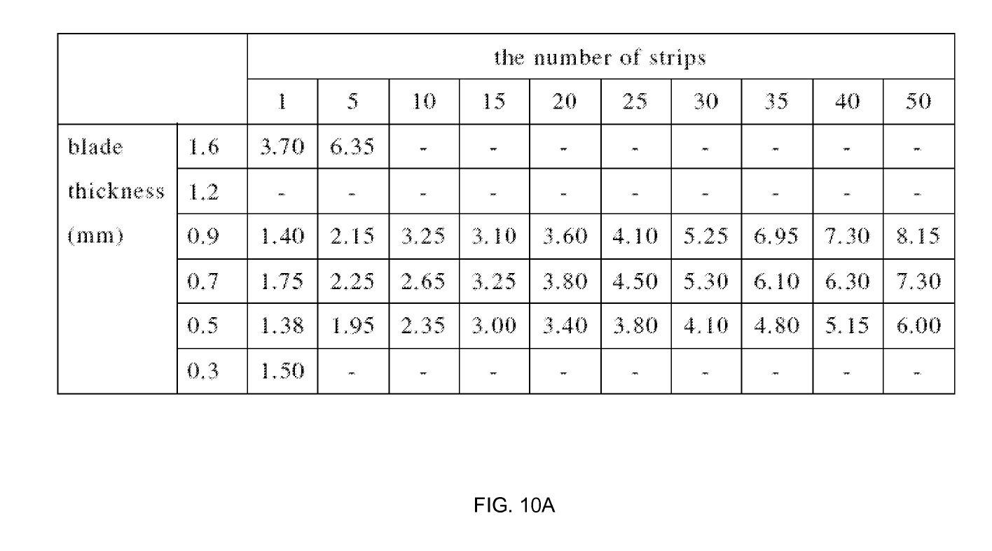

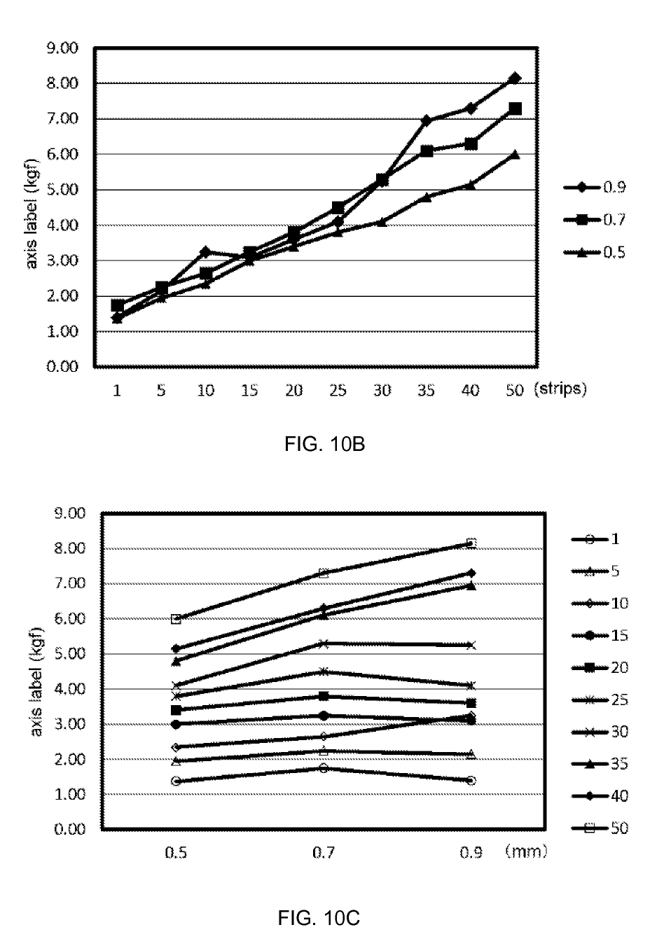

The unit of measurements in the FIG. 10A is the kilogram-force (kgf). The minus sign in the FIG. 10A indicates that the force exerted on the blade 18 could not be measured because the blade 18 was impaired.

As apparent from the FIG. 10A above, the blade 18 of 1.6 mm thick could cut through one and five strips of paper but could not cut through the object when the object was a stack of ten or more strips.

The blade 18 of 1.2 mm thick could not cut through the object which was a single strip of paper. Essentially, the blade 18 of 1.2 mm thick can cut through the object when it is a stack of around ten paper strips. In the results reported herein, however, it would appear that the blade 18 was impaired due to its receiving an excessive force for some reason. According to the results of simulation made by the present inventor, the blade 18 of 1 mm thick can cut through the object when the object is a stack of fifty paper strips without impairment of the blade 18.

In a similar way, the blade 18 of 0.3 mm thick could cut through a single strip of paper but the blade 18 was impaired when the object was a stack of five or more strips. It is believed that this happened because the blade 18 was too thin and did not have enough strength. According to the results of simulation made by the present inventor, the blade 18 of 0.4 mm thick can cut through the object when the object is a stack of fifty paper strips without impairment of the blade 18.

Furthermore, the each of the blades of 0.9 mm, 0.7 mm, and 0.5 mm thick could cut through the object ranging from a single paper strip to a stack of fifty paper strips. The forces exerted on the blades are notable. For example, when the object was a single paper strip, the forces exerted on the blades of 0.9 mm, 0.7 mm and 0.5 mm thick were 1.40 kgf, 1.75 kgf, and 1.38 kgf, respectively. These values are significantly smaller than 3.70 kgf exerted on the blade of 1.6 mm thick. The same applies to the object consisting of five paper strips. When the object was a stack of fifty paper strips, the forces exerted on the blades of 0.9 mm, 0.7 mm, and 0.5 mm were 8.15 kgf, 7.30 kgf, and 6.00 kgf, respectively. These forces are similar to the force (6.35 kgf) exerted on the blade when the blade of 1.6 mm thick was used to cut through a stack of five paper strips. The aforementioned results indicate that the forces exerted on the blade to cut through the object are significantly small with the blade having a thickness of 0.9 mm, 0.7 mm or 0.5 mm.

In addition, when the blade of 0.3 mm thick was used to cut through a single paper strip, the blade received a force of 1.50 kgf. This indicates that the force exerted on the blade of 0.3 mm thick to cut through the object is not much different from the forces exerted on the blades of 0.9 mm, 0.7 mm, and 0.5 mm thick. A trial to cut through the five or more paper strips with the blade of 0.3 mm thick, however, resulted in impairment of the blade. A possible reason for this lies in that the blade itself did not have enough strength as described above, though the force exerted on the blade of 0.3 mm thick from the object is not so large because the thickness is not larger than 0.9 mm.

Among the results of the trials described above, those obtained with the blades of 0.9 mm, 0.7 mm, and 0.5 mm thick are represented as a graph in FIG. 10B. The vertical axis of the graph indicates values displayed on the display box 220 of the weight scale, and the horizontal axis indicates the number of paper strips.

According to the FIG. 10B, the forces exerted on the blades of 0.9 mm, 0.7 mm, and 0.5 mm thick upon cutting of the object are not much different from each other when the object is a small number of paper strips. A significant difference can be observed among the forces exerted on the respective blades at or around the point where the number of paper strips in the object exceeds 25. A possible reason for this is as follows. A sharpened portion of the blade 18 (i.e., the portion having a height indicated by “h” in FIG. 8B) is considered to receive a significant amount of force from the object upon cutting of the object, and this height is increased with the increase of the thickness of the blade 18, provided that the edge angle is identical. Therefore, a thicker blade would serve to allow the blade to receive a larger force when the object of a certain thickness is to be cut.

Among the results of the trials described above, those obtained with the blades of 0.9 mm, 0.7 mm, and 0.5 mm thick are represented as another graph in FIG. 10C. The vertical axis of the graph again indicates values displayed on the display box 220 of the weight scale, and the horizontal axis indicates the thickness of the blade 18.

According to FIG. 10C, as compared to a case where the blade 18 has the thickness of 0.5 mm, it can clearly be seen that the force exerted on the blade 18 increases more and more as the thickness of the blade 18 is incremented by 0.2 mm from 0.5 mm to 0.9 mm as a result of the increase of the number of paper strips.

1. A stack cutter comprising:
a blade for cutting an object, an edge of the blade being pressed against and generally parallel to a surface of the object, wherein the blade has a thickness of 1 mm or smaller;
handling means for being operated by a user so that the blade located away from the object moves toward the object; and
linking means for transmitting a force exerted on the handling means to the blade.

2. The stack cutter according to claim 1, wherein the blade has a thickness of 0.9 mm or smaller.

3. The stack cutter according to claim 1, wherein the blade has a thickness of 0.7 mm or smaller.

4. The stack cutter according to claim 1, wherein the blade has a thickness of 0.5 mm or smaller.

5. The stack cutter according to claim 1, wherein the blade has a thickness of 0.4 mm or larger.

6. The stack cutter according to claim 1, wherein an edge angle of the blade falls within a range of 30°±5°.

7. The stack cutter according to claim 1, wherein the blade comprises a carbon tool steel or a steel material having at least the same hardness as the carbon tool steel.

8. A blade for being used in a stack cutter, the stack cutter comprising the blade for cutting an object, an edge of the blade being pressed against and generally parallel to a surface of the object, handling means for being operated by a user so that the blade located away from the object moves toward the object, linking means for transmitting a force exerted on the handling means to the blade, and fixing means being capable of removably fixing the blade attached to the linking means, wherein the blade has a thickness of 1 mm or smaller and has a fixed portion capable of being removably engaged with the fixing means.
